(19) United States
(12) Patent Application Publication
(10) Pub. No.: US 2017/0330103 A1
(43) Pub. Date: Nov. 16, 2017

(54) Systems and Methods for Learning Appliance Signatures

(71) Applicants: Alex Shyr, Mountain View, CA (US); Vivek Garud, Cupertino, CA (US); Abhay Gupta, Cupertino, CA (US)

(72) Inventors: Alex Shyr, Mountain View, CA (US); Vivek Garud, Cupertino, CA (US); Abhay Gupta, Cupertino, CA (US)

(21) Appl. No.: 15/289,175

(22) Filed: Oct. 9, 2016

Related U.S. Application Data
(60) Provisional application No. 62/336,213, filed on May 13, 2016.

(51) Int. Cl. G06N 99/00; G06N 5/04

(52) U.S. Cl. CPC G06N 99/005; G06N 5/047

(57) ABSTRACT

The present invention is generally directed to systems and methods for learning appliance signatures based at least in part upon, energy disaggregation techniques and user input Methods of the present invention may include retrieving energy consumption data pertaining to at least one home environment comprising one or more appliances; identifying one or more patterns in the energy consumption data by applying signal processing algorithms to the consumption data; generating at least one question for a user based at least in part on the one or more patterns; receiving a user input In response to the question; determining at least one appliance in the home environment, based at least in part on the one or more patterns and the user input; and determining an appliance signature by extracting a canonical pattern from the energy consumption data based at least in part on the user input.

The present invention is generally directed to systems and methods for learning appliance signatures utilizing energy disaggregation techniques. More specifically, the present invention is directed to learning appliance signatures using both energy disaggregation techniques and user feedback. Such learned signatures may then be used to improve the quality of disaggregation.

### BACKGROUND

Energy disaggregation has received an increasing amount of attention in recent years. With the growing market adoption of smart meters and home-area network (HAN) devices, the availability of high-resolution consumption data may no longer be a limiting factor in non-intrusive load monitoring (NILM) research. However, the amount of labelled and annotated datasets has lagged behind NILM research, and may be seen by many as a potential bottleneck in advancing the research.

Often labelled datasets are collected by measuring plug-level loads in a few wired-up homes. However, this method may not be scalable, because as the number of appliances in the home grows collecting ground-truth labels become more laborious and expensive. Moreover, such collected data is generally static and it does not adapt to changing user behaviour or new appliances.

A potential alternative approach is to pose a question to user every time any appliance turns on (whenever a significant change in consumption level occurs). However, this approach also has numerous drawbacks. For example, this unintelligent mechanism may result in a myriad of inquiries presented in any manner (rather than prioritized). Such unintelligent questioning may also create an undesirable user experience. In general, such mechanisms may be lacking any notion of appliance pattern and may be incapable of detecting a “session” of appliance usage.

Accordingly, a need of system and/or method that poses intelligent questions to the user and robustly incorporates user input into disaggregation pipeline to determine an energy label or signature for an appliance present in a home environment is desirable.

### SUMMARY

Aspects in accordance with some embodiments of the present invention may include a method of learning appliance signatures for appliance detection, comprising retrieving energy consumption data pertaining to at least one home environment from an energy meter, wherein the at least one home environment comprises one or more appliances; identifying one or more patterns in the energy consumption data by applying signal processing algorithms to the consumption data; generating at least one question for a user based at least in part on the one or more patterns; receiving a user input in response to the at least one question generated from a user device; determining at least one appliance in a running mode, amongst the one or more appliances in the at least one borne environment, based at least in part on the one or more patterns and the user input; and determining an appliance signature by extracting a canonical pattern from the energy consumption data based at least in part on the user input.

Some aspects in accordance with some embodiments of the present invention may include a system for learning appliance signatures for energy disaggregation, wherein the system comprises: one or more hardware processors; and a memory communicatively coupled to the one or more hardware processors storing instructions, that when executed by the one or more hardware processors, cause the one or more hardware processors to perform operations comprising: retrieving energy consumption data pertaining to at least one home environment from an energy meter, wherein the at least one home environment comprises one or more appliances; identifying one or more patterns in the energy consumption data by applying signal processing algorithms to the energy consumption data; generating at least one question for a user based at least in part on the one or more patterns; receiving a user input in response to the at least one question generated from a user device; determining at least one appliance in a running mode, amongst the one or more appliances in the at least one home environment, based at least in part on the one or more patterns and the user input; and determining an appliance signature by extracting a canonical pattern from the energy consumption data based at least in part on the user input.

It is to be understood that both the foregoing general description and the following detailed description are exemplary and explanatory only and are not restrictive of the invention, as claimed.

### BRIEF DESCRIPTION OF THE DRAWINGS

The present invention can be more folly understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 2 illustrates an exemplary system for learning appliance signatures for appliance detection, in accordance with some embodiments of the present invention.

FIG. 2 illustrates an exemplary appliance signature for a dishwasher (DW), in accordance with some embodiments of the present invention.

FIG. 3 illustrates an exemplary appliance signature for a washing machine (WM), in accordance with some embodiments of the present invention.

FIG. 4 illustrates an exemplary method for learning appliance signatures for appliance detection, in accordance with some embodiments of the present invention.

Before any embodiment of the invention is explained in detail, it is to be understood that the present invention is not limited in its application to the details of construction and the arrangements of components set forth in the following description or illustrated in the drawings. The present invention, is capable of other embodiments and of being practiced or being carried out In various ways. Also, it is to be understood that the phraseology and terminology used herein is for the purpose of description and should not be regarded as limiting.

### DETAILED DESCRIPTION

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. In the present document, the word “exemplary” is used herein to mean “serving as an example, instance, or illustration.” Any embodiment or implementation, of the present subject matter described herein as “exemplary” is not necessarily to be construed as preferred or advantageous over other embodiments. Moreover, as used herein, the singular may be interpreted in the plural, and alternately, any term in the plural may be interpreted to be in the singular. Unless otherwise indicated, the terms used in this document should be read in accordance with common usage.

While the disclosure is susceptible to various modifications and alternative forms, specific embodiment thereof has been shown by way of example in the drawings and will be described, in detail below. It should be understood, however that it is not intended to limit the disclosure to the particular forms disclosed, but on the contrary, the disclosure is to cover all modifications, equivalents, and alternative tailing within the scope of the disclosure.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

It is typically observed in energy consumption data stream of a typical day that most appliances are in similar amplitude or wattage. In such cases, a simple transient-based system that raises an inquiry to the user when a significant surge in power is observed may have difficulty figuring out appliance sessions. The situation may get further complicated in cases of overlapping appliance usage. Hence, it is important to determine appliance signatures or label to avoid such confusion.

The present subject matter for learning appliance signature for appliance detection, in accordance with the present subject matter, is described in detail in conjunction with FIGS. 1-4. It should be noted that the description and drawings merely illustrate the principles of the present subject matter, it will thus be appreciated that those skilled in the art will be able to devise various arrangements that, although not explicitly described or shown herein, embody the principles of the present subject matter and are included within its spirit and scope. While aspects of the platform and method can be implemented in any number of different environments, and/or configurations, the embodiments are described in the context of the following exemplary system architecture(s).

In general, the present invention is directed to systems and methods that may pose intelligent questions to the user, and robustly incorporates the user input into the energy disaggregation techniques. Without prior knowledge or previously available user information, the present invention may adapt to each user's consumption patterns and gradually detect existing appliances.

FIG. 1 illustrates an exemplary system 100 for teaming appliance signatures for appliance detection, in accordance with some embodiments of the present invention. As shown in FIG. 1, system 100 may comprise a remote processor 110, an energy disaggregation pipeline 120, and a user device 130. The remote processor 110 may be communicatively coupled to both the energy disaggregation pipeline 120 and the user device 130. In addition, the user device 130 may be communicatively coupled to the energy disaggregation pipeline 120.

The remote processor 110 may comprise at least an analyzer 111 and an inquiry generation unit 112. In general, analyzer 111 may create templates to be used by the energy disaggregation pipeline. Such templates (in a potential and/or a final state) may be used by the energy disaggregation pipeline to provide more accurate appliance level energy disaggregation. For example, analyzer 111 may analyze energy consumption data and identify repeating patterns, and/or review user answers (received from the inquiry generation unit 112) and create a canonical template for any identified or tagged appliances.

Inquiry generation unit 112 may be a unit or module that may determine, based on both energy disaggregation patterns and certain psychological principals (as discussed below), questions to be posed to users. Inquiry generation unit 112 may prioritize questions to obtain more useful or pertinent identifications sooner.

In general, the energy disaggregation pipeline 120 may represent data to which energy disaggregation principals and techniques may have already been applied. For example, the energy disaggregation pipeline 120 may represent whole-house profile data to which certain disaggregation techniques have been applied. The use of the analyzer 111 and inquiry generation unit 112 of the processor 110 may provide further analysis and determine and/or apply home specific, user verified templates. Such information from the processor 110 may be provided back into the energy disaggregation, pipeline 120 for further use and/or processing.

In general, the user device 130 may be any user device that is capable of receiving questions in one or more various formats from the inquiry generation unit 112 and providing a response. User devices 130 may include, but are not limited to computing devices (such as but not limited to personal computers, laptop computers, tablet computers), mobile communication devices (such as but not limited to smart phones, mobile phones, personal digital assistants (PDAs), navigation systems, etc.), programmable thermostats, smart-home interactive displays, etc. User devices 130 may further comprise typical wired home phones.

In operations, the analyzer 111 may receive energy consumption data of appliances in a home environment from the energy disaggregation pipeline 120. In an example, the analyzer 111 may receive the energy consumption data from an energy meter installed in the home environment (such as but not limited to a Smart Meter, clamp-on energy meter (such as a current clamp (CT clamp), and/or via a meter connected to a home area network), or from other data sources (such as but not limited to a Zigbee connection, a utility, etc. The energy consumption data may be obtained at a predefined sampling rate. In an example, the analyzer 111 may receive the energy consumption data at the predefined sampling rate ranging from millions of samples per second to one sample per minute. The energy consumption data may also comprise active power, reactive power, apparent power and/or separate readings from different phases indicating specific energy characteristic of various appliances used by a user.

Once the energy consumption data is obtained, the analyzer 111 may analyze the energy consumption date to identity one or more patterns in the energy consumption data. This may be accomplished through a variety of methods, such as but not limited to by applying signal processing algorithms to the energy consumption data. The energy consumption data may correlate closely with user behaviour. For example, the energy consumption data may indicate when a user began using a new appliance, or when the user began using the same appliance at a different time of day. Such patterns may be obtained by analyzing the energy consumption data by analyzer 111.

The analyzer 111 may learn an appliance signature for an appliance selected by a user. In an example, the analyzer 111 may learn the appliance signature by extracting a canonical pattern from the energy consumption data based on user input (that is, a user's response to one or more questions posed by the inquiry generation unit 112). The canonical patterns may be broadly understood by the analyzer 111 as single appliance amplitude, a foil state machine of transitions, histogram or densitogram of transitions, and/or full raw signature data. The analyzer 111 may extract common elements from one or more patterns for which the user has provided input, via techniques including pattern matching and clustering to form the canonical pattern. The appliance signature may be understood as a state machine or a combination of histogram and densitogram transitions, as well as non-transient information such as time-of-day and frequency of usage. Thereafter, the learned appliance signature may be tagged to the appliance and provided to the energy disaggregation pipeline 120.

Further, in another example, the analyzer 111 may monitor an energy consumption pattern of the home environment to detect switching on of an appliance. The analyzer 111 may look tor transition in the energy consumption pattern to detecting the switching on of the appliance. Once the transition is detected by the analyzer 111, the inquiry generation unit may generate an inquiry for the user to identify the appliance just switched on. Once the analyzer 111 receives a user response to the inquiry indicating the appliance switched on, the analyzer 111 may record and analyze the energy consumption data to determine an appliance signature for the appliance. It may be noted that the energy consumption data may be recorded by the analyzer 111 in real time upon switching on of the appliance.

In addition to analysing information in the energy disaggregation pipeline and identifying patterns, analyzer 111 may also determine whether user input, received in response to a question posed by the inquiry generation unit 112, may be sufficient to determine the appliance signature for the appliance signature. If the analyzer 111 determines that the user input may not be sufficient to determining the appliance signature, it may prompt the inquiry generation unit 112 to generate additional questions for the user. However, if the analyzer 111 determines that the user input is sufficient to determine the appliance signature, the analyzer 111 may proceed to the next step of determining the appliance and the appliance signature. Subsequently, the analyzer 111 may determine at least one appliance in a running mode in the home environment based on the one or more patterns and the user input.

In some circumstances, rather than ask a user about prior or previous usage, the user may be prompted to perform an action in the future. For example, the user may be prompted to turn a specific appliance on at a certain lime (or within a certain period). In general, the inquiry generation unit 112 may instruct a user to switch on an appliance. The analyzer 111 may receive a user notification. Indicating switching on of the appliance, along with an indication of a type or name of the appliance (which may be manually entered or selected from a provided list). Once the user notification is received and the appliance is switched on, the analyzer 111 may start recording energy consumption data corresponding to the appliance. It may be noted that the energy consumption data may be recorded by the analyzer 111 in real time or in predefined intervals of time. Thereafter, the analyzer 111 may analyze the energy consumption data to determine an appliance signature for the appliance.

It can be seen above that the analyzer 111 and the inquiry generation unit 112 work together to determine both user questions and how to apply and/or use answers to such user questions. In general based on one or more patterns determined or recognized by the analyzer 11, the inquiry generation unit 112 may generate at least one question for the user. The inquiry generation unit 112 may then provide at least one question to the user device 130.

In an example, to generate the questions, the inquiry generation unit 112 may consider historical energy consumption data and select patterns that are consistently recurring. For example, signal-level pattern self-matching may be used by the inquiry generation unit 112 to determine a consistent match while allowing for variability in the usage behavior. Further, some other methods that may be used may include auto-correlation, dynamic time warping to allow for temporal flexibility, frequency domain features such as Fourier and Wavelet coefficients, distance metrics such as earth movers distance and edit distance, clustering techniques such as hierarchical and spectral. In an example, auxiliary information such as context (e.g. time of use), demographic data and geographic info may also be utilized.

Moreover, the inquiry generation unit 112 may determine various characteristics of questions in order to most likely (i) elicit a response; (ii) elicit an accurate response; and/or (iii) not annoy or irritate a user (in order to encourage answering future questions). Based at least in part upon psychological studies on human behavior, the timing, channel of communication, and format of question may be varied in order to solicit best answer from users in most pleasant and engaging manner.

For example, the timing of the questions may be varied. The timing should be convenient (for example, a user should not be asked at 3:00 AM if his or her pool pump just turned on). Similarly, frequency may be varied. For example, a user may be irritated with too many questions, but may also be more likely to respond in “spurts”—and such periods of response may be taken advantage of.

Moreover, the channel of communication may be determined to be convenient to the user. As different people prefer different manners of communication, this determination may be more individual, or broken by demographics. For example, some people (and/or age groups) may prefer communication via texts, while others may prefer an email or phone call via an IVR system. Some questions may be more likely answered if presented on a programmable thermostat or asked via a user application. The inquiry generation unit 112 may determine a likely acceptable and/or convenient channel to elicit a response.

In addition, the actual phrasing of the question may encourage or discourage a response or an accurate response. For example, context anchoring such as “after the dryer last night” and “first thing every morning” may help the user remember appliance usage more accurately.

In one example, to generate the questions in real time or near real time, the analyzer 111 may analyze the energy consumption data to determine a partial appliance signature. Thereafter, the inquiry generation unit 112 may obtain the partial appliance signature and generate at least one question, for the user in real time or near real-time, based on the partial appliance signature. In another example, the inquiry generation unit 112 may consider the historical consumption data and the one or more patterns as well while generating the questions in real time.

Inquiry generation unit 112 may further consider one or more factors in generating questions. Such factors may include, but are not limited to, (i) limited memory of users; (ii) inevitable mistakes; (ii) intuitive context; etc. With regard to limited memory, users may often forget which appliances they started, let atone when. The inquiries therefore should be timely. Further, as noted above, the inquiry generation unit 112 may provide the questions to the user when it is convenient and natural to the user. With regard to inevitable mistakes, the system 100 should robustly deal with unavoidable erroneous input or answers provided by users tor which users are unsure of the accuracy. With regard to intuitive context anchoring questions to events may assist users in accurate responses. For example, many users may remember usage events in context, rather than in absolute terms (for example, “running dryer after washing machine”, or “turning on heater in after waking up”).

Subsequently, the inquiry generation unit 112 may receive from the user device 130 a user input in response to the at least one question generated. The user input may indicate a response to the question posed. In an example, the question may be as simple as “what was running at 7 pm today?” In such a case the user may respond to the question by selecting one of the appliances that was running at 7 pm. (Note that the user may be provided with a listing of appliances to select from, or may be asked to manually enter the identification of the appliance).

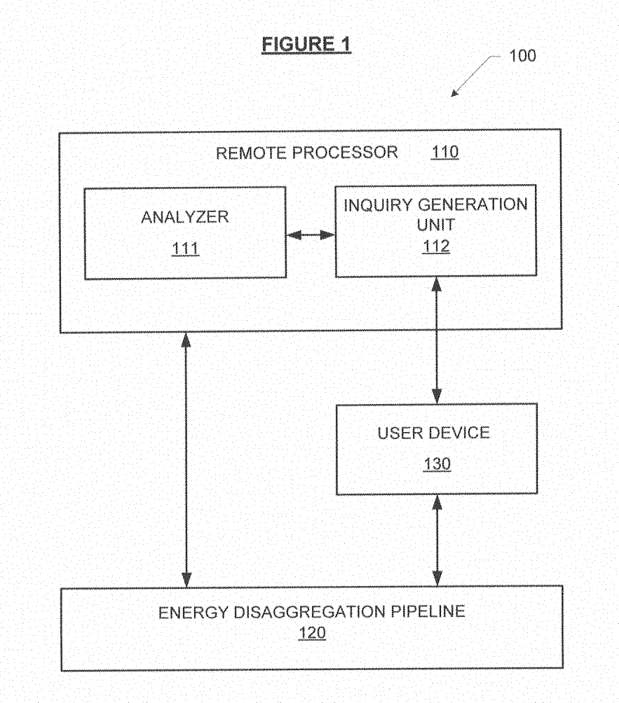

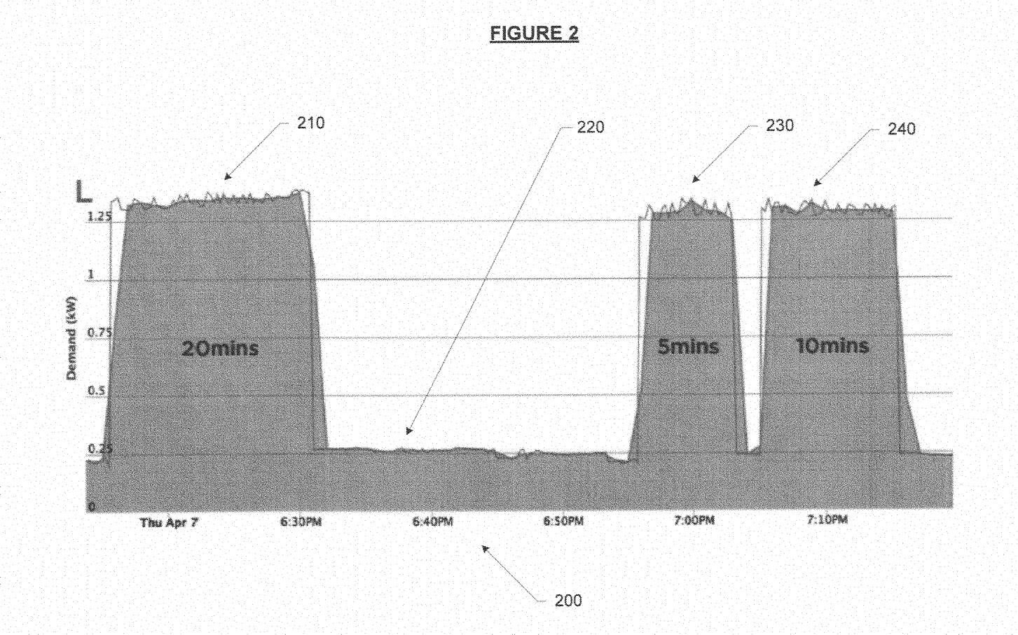

With reference to FIG. 2 illustrates an exemplary appliance signature 200 for a dishwasher (DW), in accordance with some embodiments of the present invention. As shown in FIG. 2, dishwasher cycle may last about an hour, with three (3) heating pulses of approximately 1 kW each. With reference to FIG. 2, pulse 210 may be an initial pulse to heat the water and soak the dishes with soap. There may be a period 220 of less energy usage as the water is already heated and the dishes are being soaked/sprayed. There may be a later pulse 230 where water may be heated again, and later at 240 the heated water may be used to rinse soap off the dishes.

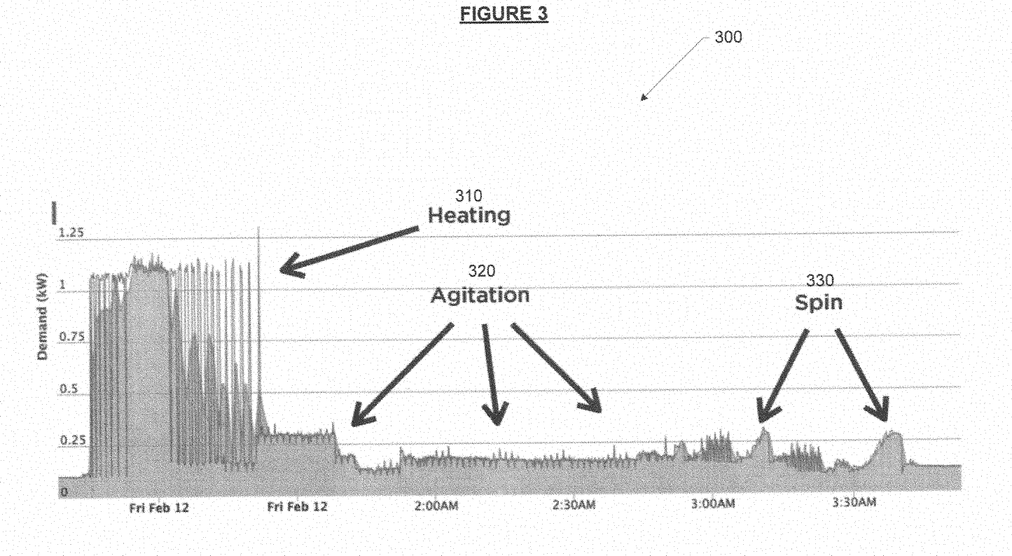

With reference to FIG. 3, an exemplary appliance signature 204 for a washing machine (WM) in accordance with some embodiments of the present invention will now be discussed. As shown in FIG. 3, a washing machine cycle may last approximately 2.5 hours. Initial pulses heats the water and washes the clothes. In the middle, pulses are low as the wet clothes are then agitated to clean. The latter pulses are due to spinning cycles which dry out the remaining water. More specifically, heating pulses may be seen at 310. Agitation pulses—which may be seen to use less energy—axe shown at 320. Energy pulses attributable to spin cycles may be seen at 330.

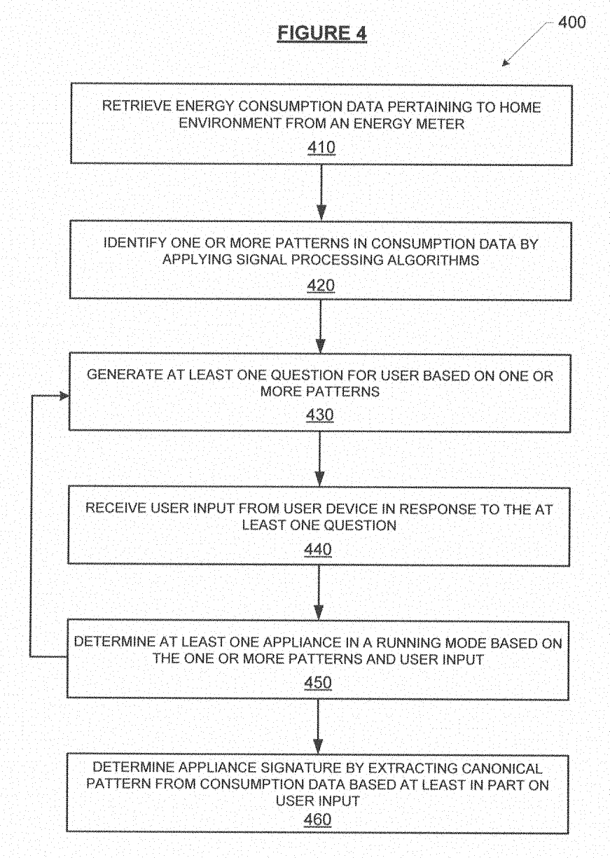

With reference to FIG. 4, an exemplary method for learning appliance signature for energy disaggregation, in accordance with some embodiments of the present invention will now be discussed.

In general, method 400 may be described in the general context of computer executable instructions. Generally, computer executable instructions can include routines, programs, objects, components, data structures, procedures, modules, and functions, which perform particular functions or implement particular abstract data types. The method 400 may also be practiced in a distributed computing environment where functions are performed by remote processing devices that are linked through a communication network. In a distributed computing environment, computer executable instructions may be located in both local and remote computer storage media, including memory storage devices. The order in which the method 400 described is not intended to be construed as a limitation (unless clear from the recitation of the steps), and any number of the described method blocks can be combined in any order to implement the method 400 or alternative methods. Additionally, individual blocks may be deleted from the method 400 without departing from the spirit and scope of the subject matter described herein.

With continued reference to FIG. 4, at 410 energy consumption data pertaining to at least one borne environment may be received from an energy meter. As noted above, energy meter may take any form. The home environment providing the energy consumption data may have one or more appliances that are used by a user. The energy consumption data may also comprises active power, reactive power, apparent power and/or separate readings from different phases indicating specific energy characteristic of various appliances used by a user. In some cases, the consumption data may be obtained at a predefined sampling rate. In an example, the predefined sampling rate may range from millions of samples per second to one sample per minute.

At step 420, one or more patterns may be identified, in the energy consumption data. For example, signal processing algorithms may be applied to the energy consumption data, and an analyzer (such as analyzer 111 in FIG. 1) may identify patterns in the energy consumption data. As noted above, an analyzer may employ various signal processing methods and correlation techniques to identity the patterns in the energy consumption data.

At step 430, at least one question for a user may be generated. Such question may be based at least in part on the one or more patterns identified in the previous step. Once the one or more patterns are identified, an inquiry generation unit (such as inquiry generation unit 112 in FIG. 1) may generate the at least one question for a user. In generating the question, the inquiry generation unit may consider various items, including for example, the one or more patterns and historical consumption data.

In accordance with some embodiments of the present invention, questions may be posed to users in real time or near real time. In order to ask a question in real time or near real time, a partial appliance signature may be extracted or determined by analysing the energy consumption data. Thereafter, the inquiry generation unit may generate the at least one question based on the partial appliance signature in real time. It may be noted that the inquiry generation unit may also consider the historical consumption data and the one or more patterns along with the partial appliance signature to generate the at least one question for the user, without deviating from the scope of the invention. In an example, the at least one question may be provided to the user through a variety of channels, including but not limited to, a mobile application, email, short message services (SMS), or Interactive voice response (IVR) call on a user device.

At step 440, user input may be received from a user device (such as user device 130 as discussed above) in response to the at least one question generated. The user input may comprise a response to the at least one question.

At step 450, at least one appliance may be determined based on the one or more patterns and the user input. In general, an analyzer may analyze the energy consumption data along with the user input to determine the at least one appliance. The analyzer may analyze the user input to determine whether the user input is sufficient to assign the appliance signature to a specific appliance for at least make such assignment with a degree of confidence). Similar to as discussed above, if analyzer identifies that the user input is insufficient to confidently determine the appliance signature, additional questions may be posed to the user. This is graphically represented by the feedback loop in FIG. 4 between step 450 and 430. If it is determined that the user input is sufficient for determining and assigning the appliance signature, the process may proceed. Once the appliance is determined, the analyzer may then determine an appliance signature for each of the at least one appliance.

At step 460, the appliance signature may be determined. For example, the appliance signature may be determined or identified by extracting a canonical pattern from the energy consumption data based on the user input. Moreover, the appliance signature may be tagged with at least one appliance. Note that the appliance signature may be understood as a state machine of transitions or a combination of histogram and densitogram transitions, as well as non-transient information such as time-of-day and frequency of usage.

In accordance with some embodiments of the present invention, in order to assist the analyzer in determining the appliance signature, a user may be instructed by an inquiry generation unit to switch on an appliance. Upon receiving the instructions, the user may provide a notification to the analyzer that the appliance was turned on. The analyzer may then initiate recording of the energy consumption data of the appliance indicated in the user notification. Note that energy consumption data may be obtained by an analyzer in real time, near real time, or after predefined intervals of time. The energy consumption data may be analyzed by the analyzer to determine an appliance signature for the appliance switched on by the user.

In another example, an energy consumption pattern in the home environment may be monitored by the analyzer to detect any changes and/or transition in the energy consumption pattern. If a transition is detected in the energy consumption pattern, the analyzer may determine that an appliance has been switched on. Thereafter, inquiry generation unit may generate an inquiry for the user to identify the appliance that was recently switched on. If the appliance is determined based on an input received from the user, the analyzer may record and analyze energy consumption data to determine an appliance signature for the appliance. The appliance signature may be provided back to an energy disaggregation pipeline for later use by a system for both the same home, and potentially for other homes with different energy usage profiles. In this manner, the some embodiments of the present invention may generate intelligent questions and determine appliance signature or labels for the appliances using crowdsourcing.

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense, and that the scope of the invention will be solely determined by the appended claims.

We claim:

1. A method of learning appliance signatures for appliance detection, comprising:
retrieving energy consumption data pertaining to at least one home environment from an energy meter, wherein the at least one home environment comprises one or more appliances;
identifying one or more patterns in the energy consumption data by applying signal processing algorithms to the consumption data;
generating at least one question for a user based at least in part on the one or more patterns;
receiving a user input in response to the at least one question generated from a user device;
determining at least one appliance in a running mode, amongst the one or more appliances in the at least one home environment, based at least in pan on the one or more patterns and the user input; and
determining an appliance signature by extracting a canonical pattern from the energy consumption data based at least in part on the user input.

2. The method of claim 1 further comprising providing an appliance run information to the user, wherein the appliance run information indicates a start time, end time, run time, or/or temporal memory cues.

3. The method of claim 1, wherein receiving the user input further comprises:
determining whether the user input in conjunction with the one or more patterns is sufficient to determine the appliance signature; and
upon a determination that the appliance signature in conjunction with the one or more patterns in insufficient to determine the appliance signature, generating additional questions for the user.

4. The method of claim 1, wherein the energy consumption data comprises active power, reactive power, apparent power, and/or separate readings from different phases indicating specific energy characteristic of various appliances used by the user.

5. The method of claim 1, wherein generating the at least one question further comprises:
extracting a partial appliance signature by analysing the energy consumption data in real time or near real time; and
dynamically generating the at least one question for the user based at least in part on the partial appliance signature, the one or more patterns and/or historical consumption data.

6. The method of claim 1, wherein learning the appliance signature further comprises tagging the appliance signature to an appliance present in the at least one home environment.

7. The method of claim 1, further comprises:
sending a communication to a user device, the communication requesting the user switch on an appliance;
receiving a user notification indicating switching on the appliance;
recording energy consumption data of the appliance upon receiving the user notification, wherein the energy consumption data is obtained in real time, near real time, or after predefined intervals of time; and
wherein determining the appliance signature comprises analysing the energy consumption data.

8. The method of claim 1 further comprises:
detecting switching on of the appliance based at least in part on transition in an energy consumption pattern;
generating an inquiry for the user to identify the appliance switched on;
recording energy consumption data of the appliance determined based at least in part on the inquiry, wherein the energy consumption data is obtained in real time or near real time; and
wherein determining the appliance signature comprises analysing the energy consumption data.

9. A system for learning appliance signatures for energy disaggregation, wherein the system comprises:
one or more hardware processors; and
a memory communicatively coupled to the one or more hardware processors storing instructions, that when executed by the one or more hardware processors, cause the one or more hardware processors to perform operations comprising:
retrieving energy consumption data pertaining to at least one home environment from an energy meter, wherein the at least one home environment comprises one or more appliances;
identifying one or more patterns in the energy consumption data by applying signal processing algorithms to the energy consumption data;
generating at least one question for a user based at least in part on the one or more patterns;
receiving a user input in response to the at least one question generated from a user device;
determining at least one appliance in a running mode, amongst the one or more appliances in the at least one home environment, based at least in part on the one or more patterns and the user input; and
determining an appliance signature by extracting a canonical pattern from the energy consumption data based at least in part on the user input.

10. The system of claim 9, wherein the operations further comprise providing an appliance run information to the user, wherein the appliance run information indicates a start time, end time, run time, and/or temporal memory cues.

11. The system of claim 9, wherein receiving the user input further comprises:
determining whether the user input in conjunction with the one or more patterns is sufficient to determine the appliance signature; and
upon a determination that the user input in conjunction with the one or more patters is insufficient to determine the appliance signature, generating additional questions for the user.

12. The system of claim 9, wherein the energy consumption data comprises active power, reactive power, apparent power, and/or separate readings from different phases indicating specific energy characteristic of various appliances used by the user.

13. The system of claim 9, wherein generating the at least one question further comprises:
extracting a partial appliance signature by analysing the energy consumption data in real time or near real time; and
dynamically generating the at least one question for the user based on the partial appliance signature, the one or more patterns, and/or historical consumption data.

14. The system of claim 9 wherein the operations further comprise:
sending a communication to a user device, the communication requesting the user switch on an appliance;
receiving a user notification indicating switching on the appliance;
recording energy consumption data of the appliance upon receiving the user notification, wherein the energy consumption data is obtained in real time, near real time, or after predefined intervals of time; and
wherein determining the appliance signature comprises analysing the energy consumption.

15. The method of claim 9, whereat the operations further comprise:
detecting switching on of an appliance based at least in part on transition in an energy consumption pattern
generating an inquiry for the user to identify the appliance switched on;
recording energy consumption data of the appliance determined based at least in part on the inquiry, wherein the energy consumption data is obtained in real time or near real time; and
wherein determining the appliance signature comprises analysing the energy consumption

16. A system for learning appliance signatures for energy disaggregation, based at least in part on user input, comprising:
an energy disaggregation pipeline, comprising information pertaining to appliance usages in a home environment;
a remote processor in communication with an energy disaggregation pipeline and one or more user devices, the remote processor comprising:
an analyzer, configured to recognize full and partial patterns in data received from the energy disaggregation pipeline, and determine based on user input received from the inquiry generation unit, appliance signatures; and
an inquiry generation unit, the inquiry generation unit in selective communication with one or more user devices, the inquiry generation unit configured to determine questions to be sent to the one or more user devices, based at least in part on the full and/or partial patterns determined by the analyzer, and return answers from the one or more user devices to the analyzer.
